(19) United States
(12) Patent Application Publication
(10) Pub. No.: US 2020/0390282 A1
(43) Pub. Date: Dec. 17, 2020

(54) SPICE TEMPERING APPLIANCE

(71) Applicant: Rakhi Patel, Oklahoma City, OK (US)

(72) Inventor: Rakhi Patel, Oklahoma City, OK (US)

(21) Appl. No.: 16/899,966

(22) Filed: Jun. 12, 2020

Related U.S. Application Data
(60) Provisional application No. 62/860,492, filed on Jun. 12, 2019.

(51) Int. Cl. A47J 37/10; A23L 5/10; A47J 36/20; A47J 36/34; A23L 27/14

(52) U.S. Cl. CPC A47J 37/108; A23L 5/12; A47J 36/20; A23V 2002/00; A47J 36/34; A23L 27/14; A47J 2202/00; A47J 37/101

(57) ABSTRACT

A spice tempering device. In one version, the spice tempering device includes a truncated conical container, a support member, a fitted strainer basket, and a lid. The container has an open top and a closed base, the closed base having a diameter smaller than a diameter of the open top. The fitted strainer basket is insertable through the open top of the container and holds the spices to be tempered. Oil is added to the container and the closed base is heated to temper the spices. In one version, the lid includes a spice divider with multiple slotted compartments on top of a spice tray. A slot in the spice tray can be positioned under a desired slotted compartment to add the desired spices.

### CROSS-REFERENCE TO RELATED APPLICATION/INCORPORATION BY REFERENCE STATEMENT

This application claims priority to the provisional application identified by U.S. Ser. No. 62/860,492 filed Jun. 12, 2019, and titled SPICE TEMPERING DEVICE, the entire content of which is expressly incorporated herein by reference.

### BACKGROUND OF THE INVENTIVE CONCEPTS

### 1. Field of the Inventive Concepts

The inventive concepts disclosed and claimed herein related generally to cooking and, more particularly, but not by way of limitation, to a method and device for tempering spices.

### 2. Background of the Inventive Concepts

In the preparation of various foods, spices are added to provide flavoring and coloring. Many spices have antimicrobial properties as well. Spice tempering is a cooking technique used in India and neighboring regions in which whole or ground spices are roasted in oil or clarified butter (ghee) to liberate essential oils from the spices and thus enhance their flavor. The roasted or tempered spices are then poured, together with the oil or ghee, into the prepared food prior to serving.

There has been concern regarding unhealthy fats and the effect of consuming these fats with the tempered spices. In a study published in 2010 by the “Food Chemistry” journal, researchers studied the emissions from four commonly used oils—safflower, canola, extra virgin olive and coconut. Each was heated to four temperature levels, and its emissions were analyzed for certain toxic fumes, including aldehydes, which are known to be cancer-causing. According to this study, when an oil exceeded its smoke point, the amount of toxic fumes increased significantly. (see What Are the Dangers of Heating Cooking Oil? on the website www.livestrong.com.)

Attempts to reduce the amount of oil or ghee when tempering spices typically just reduces the flavoring to the food. A need exists for a device and methods to prepare tempered spice with less oil or ghee and to also minimize seeds and cloves from popping out of the cooking vessel. It is to such a device and methods that the inventive concepts disclosed herein are directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of a spice tempering device constructed in accordance with the presently disclosed inventive concepts.

FIG. 2 is a perspective view of another spice tempering embodiment constructed in accordance with the presently disclosed inventive concept(s).

FIG. 3A is a perspective view of a truncated conical container embodiment having multiple lips.

FIG. 3B is a perspective view of a fitted strainer basket for use with the conical container of FIG. 3A.

FIG. 3C is a perspective view of a lid for use with the embodiments in FIG. 3A and 3B.

FIG. 4 is a side view of a prototype spice tempering device.

FIG. 5 is an exploded, perspective view of the prototype spice tempering device.

FIG. 6 is a top view of the prototype spice tempering device.

### DETAILED DESCRIPTION OF EXEMPLARY EMBODIMENTS

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed inventive concept(s) shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the presently disclosed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed inventive concept(s). All such similar substitutes and modifications apparent to those skilled in the art are deemed to be within the spirit, scope, and concept of the presently disclosed inventive concept(s).

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

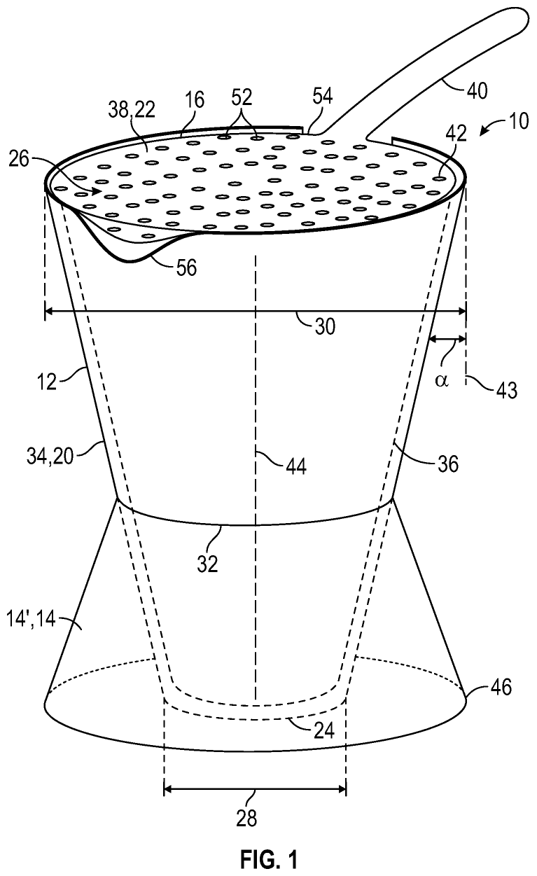

Turning now to the presently disclosed inventive concept(s) and to FIG. 1, certain embodiments thereof are directed to a spice tempering device 10 comprising a truncated conical container 12, at least one support member 14, a fitted strainer basket 16, and a lid 18. The truncated conical container 12 includes a container sidewall 20, an open top 22, a closed base 24, and an inner cavity within 26. The closed base 24 is parallel to the open top 22 and has a closed base diameter 28 smaller than a diameter 30 of the open top 22. The at least one support member 14 is attached to and extends from an outer surface 34 of the container sidewall 20 to a level the same as or below the closed base 24. The fitted strainer basket 16 is insertable through the open top 22 and into the inner cavity 26 of the truncated conical container 12. The fitted strainer basket 16 has a strainer sidewall 36, a strainer open top 38, and a strainer handle 40 extending outwardly from an upper portion 42 of the fitted strainer basket 16. The lid 18 fits over the open top 22 of the truncated conical container 12 and the strainer handle 40.

Use of the spice tempering device is described in detail later. In summary, an oil is added to the truncated conical container 12 and heated. Once the oil obtains a desired temperature, the desired spices are added to the oil in the strainer basket 16 positioned in the container 12. The truncated conical shape of the container 12 can function to minimize the amount of oil needed to cover the spices. In turn, this reduces the amount of oil, and fat contained in the oil, that must be consumed by one eating food prepared with tempered spices. The conical shape additionally assists in adding the spice. As shown in FIG. 1, the container sidewall 20 makes an angle α with a vertical line 43 parallel to an axis 44 of the truncated conical container 12. In one embodiment, the angle α is between about 10° and about 35°. In another embodiment, the angle α is between about 15° and about 30°. In yet another embodiment, the angle α is between about 15° and about 25°.

In one embodiment, the closed base diameter 28 is between about 1 and about 3 inches. In another embodiment, the closed base diameter 28 is between about 2 and about 2.5 inches.

While the container sidewall 20 can be made of a heat conducting material, in one embodiment the container sidewall 20 is made, at least in part, of a heat resistant material. This allows a user to hold or move the spice tempering device 10 with his or her hand(s) even while the oil within is hot. Examples of suitable heat resistant materials include, but are not limited to, silicone, wood, bamboo, and the like.

In contrast, the bottom or closed base 24 of the truncated conical container 12 is made, at least in part, of a heat conducting material compatible with food for human consumption. For example, the closed base 24 can be made of stainless steel, aluminum, copper, or a ceramic-coated or glass-coated metal.

In one embodiment, the entire closed base 24 is made of a heat conducting material. In another embodiment, the heat conducting material continues a short way up the container sidewall 20 from the closed base 24.

In use, the closed base 24 can be heated electrically or by placing it on a heated cooking surface such as a stove top or a pan heated on a stove top.

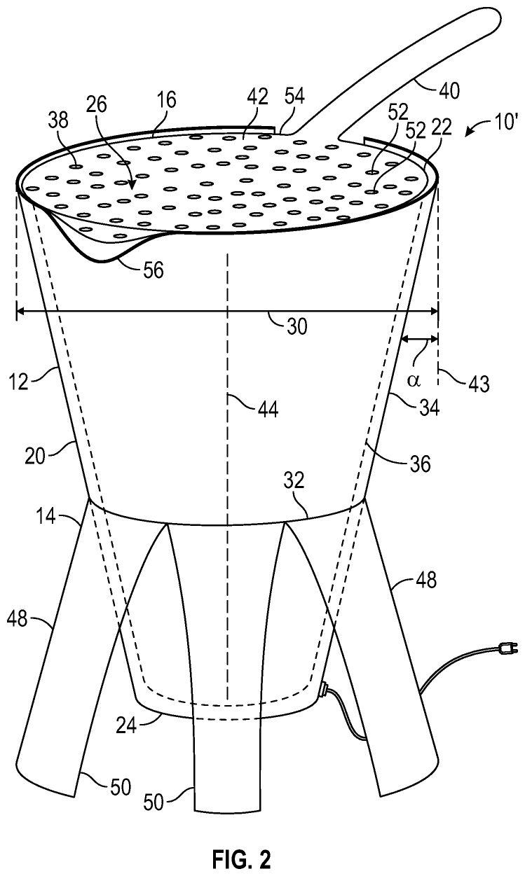

In one embodiment, and as shown in FIG. 2, the spice tempering device 10′ is heated electrically using heating elements (not shown) embedded in the closed base 24 in a manner similar to an electric coffee percolator and as understood by those in the art. In this embodiment, the heat conducting material can be used for the entire closed base 24, a portion of the closed base 24, or at least an inner portion of the closed base 24 that is in contact with the oil and the heating elements.

In one embodiment, temperature sensors (not shown) are included such as those used in coffee makers. The temperature sensors are used for sensing the temperature of the heated oil. Placement of the sensors can be, for example, within or on the container sidewall 20 relatively near the closed base 24. Design and placement of temperature sensors are well understood by those skilled in the art. Temperature indicators such as those known in the art can be positioned on any exposed portion of the spice tempering device 10 to assist the user in knowing when to add the spices.

To add stability to the spice tempering device 10, in one embodiment, at least one support member connects to or with the container sidewall 20 and extends down to a vertical position level with or lower than the closed base 24. In the embodiment shown in FIG. 1, the at least one support member 14 is shown as a truncated conical support member 14′ and has an upper rim 32 attached about an outer surface 34 of the container sidewall 20. The truncated conical support member 14′ extends downward to a position level with the closed base 24 in order to functionally provide positional support and prevent the truncated conical container 12 from tipping and accidentally spilling hot oil contained therein. This embodiment also allows the closed base 24 to contact, for example, a heated surface such as a stove top or a skillet on a heated stove top.

In one embodiment, at least end portions 46 of the truncated conical support member 14′ contacting a heated surface are heat tolerant and may also be heat-resistant and/or scratch-resistant. Examples of suitable heat resistant materials include, but are not limited to, silicone, wood, bamboo, and the like.

In one embodiment, the support member 14 comprises three or more legs 48 extending from the outer surface 34 of the container sidewall 20 downward to a position level with or lower than the closed base 24. While shown in connection with an electrically heated embodiment, clearly the three or more legs 48 could be used with the externally heated spice tempering device 10. When designed to be used on a heating surface, the legs reduce the contact of the support member 14 with the heating surface such as a stove top or a skillet on a heated stove top. In this case, feet 50 at the ends of the legs 48 are heat tolerant and may also be heat-resistant and/or scratch-resistant. Examples of suitable heat resistant materials are as above.

In one embodiment, also shown in FIG. 2, an electrically heated spice tempering device 10′ may be designed to vertically lift the closed base 24 from the end portion 26 or feet 50 of the support member 14. This arrangement can keep the heated closed base 24 from contacting a surface such as a counter top which may not be designed to contact very hot surfaces.

In one embodiment, the strainer basket 16 fits within the truncated conical container 12 such that the strainer sidewall 36 is near or adjacent the container sidewall 20, thereby minimizing the amount of oil needed to cover the spices. The strainer basket 16 can be made of any material suitable for use with food and compatible with spice tempering temperatures.

Holes 52 or perforations in the strainer basket 16 can be made any size necessary to strain out some of the larger spices. For example, the holes 52 can be smaller than most spice seeds so that the seeds can be removed prior to adding the oil to food. In another embodiment, the holes 52 are larger and the strainer basket 16 removes spice the size of whole cloves and larger.

In use, the strainer basket 16 can be lifted from the truncated conical container 12 to allow hot oil with flavoring from the spices to drain into the truncated conical container 12. While the strainer basket 16 is shown with a single handle 40, it is understood one or more handles can be used. The size and length of the strainer handle 40 can vary. For example, the strainer handle 40 can be as short as a tab.

In one embodiment, the strainer handle 40 extends outwardly in a channel-like manner and can be used to help guide spices into the strainer basket 16 and/or the truncated conical container 12.

In one embodiment, the truncated conical container 12 contains a notch 54 for positioning of the strainer handle 40.

In one embodiment, the lid 18 fits over the open top 22 of the truncated conical container 12 and keeps the hot oil contained therein from splattering. The lid can be made of any suitable food-compatible material such as glass, ceramic, and the like.

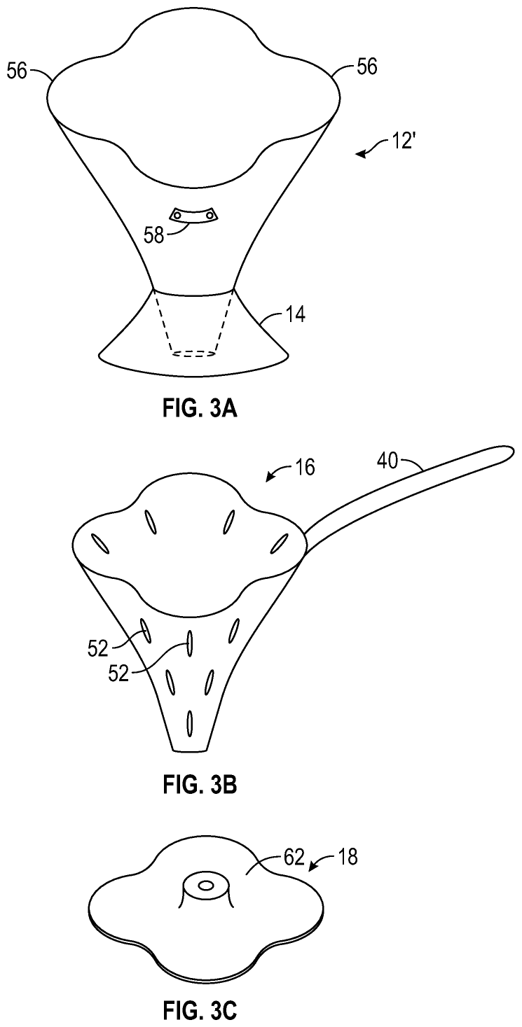

To assist with pouring the oil after tempering, the truncated conical container 12 can include one or more lips 56. For example, the truncated conical container embodiment 12′ shown in FIG. 3A provides four lips 56. The fitted strainer basket 16 shown in FIG. 3B and the lid 18 shown in FIG. 3C are likewise shaped to match the container 12′. Container handles 58 can also be included to assist in pouring of the hot oil.

Other materials that may be used in the construction of the spice tempering device 10 are well known in the art and can easily be contemplated by a person having ordinary skill in the art, and therefore these materials also fall within the scope of the presently disclosed inventive concept(s). For example, use of a heat resistant material can allow the user to hold and pour from the spice tempering device 10 by hand.

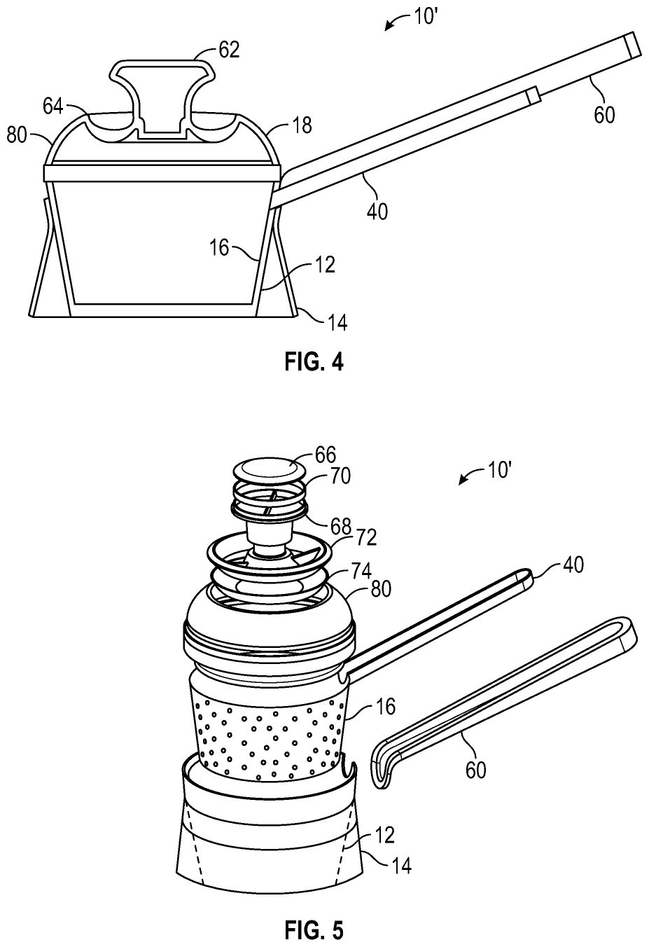

A prototype spice tempering device 10′ is shown in FIGS. 4 and 5. An elongated support member handle 60 was added and the lid 18′ was designed to include a knob 62 and a spice addition feature 64.

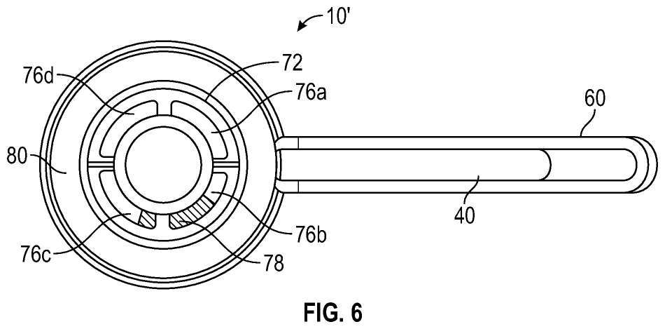

The knob 62 includes a knob top 66 connected to a knob body 68 using, for example, a press fit knob ring 70. The knob body 68 is frictionally attached to a spice divider 72 atop a spice tray 74. The prototype spice tempering device 10′ utilized a spice divider 72 having four slotted compartments, 76a-76d as shown in FIG. 6. A slot 78 in spice tray 74 can be positioned under the desired slotted compartment, 76a for example, by twisting the knob 62. This allows the spices in slotted compartment 76a to fall into the fitted strainer basket 16 and temper in the hot oil. The prototype was constructed such that the knob body 68 was frictionally attached to the spice divider 72 which could be rotated atop a fixed spice tray 74 to position the desired spices above the slot 78 in the spice tray 74.

The prototype further comprised an optional glass section 80 in the lid 10′ to allow the user to visually inspect the spice tempering process.

In one embodiment, a method for tempering spices includes the steps of partially filling an inner cavity of a spice tempering device, as described above, with an oil having a smoke point higher than the tempering temperature of the spices to be tempered. A first spice is place in the strainer basket, the first spice having the highest tempering temperature. The strainer basket is placed into the inner cavity of the spice tempering device and the oil and first spice are heated to a temperature sufficient to temper the first spice. Alternatively, the strainer basket can be placed within the inner cavity before or during heating of the oil to the desired temperature and then the first spice can be added to the strainer basket.

The oil is then allowed to cool to the tempering temperature of a second spice, and once cooled, the second spice is added to the strainer basket and tempered. This process can be repeated for any number of desired spices. Once all the desired spices have been tempered, the strainer basket is removed from the inner cavity and the strained spices can be discarded. The oil can then be poured from the truncated conical container onto a food, the oil now containing flavors from the tempered spices.

Care should be taken to choose a tempering oil with a smoke temperature above that needed to temper the desired spices. Table 1 below shows the smoke temperatures of a number of common cooking oils.

TABLE 1
Smoke Point of Different Cooking Oils, ° C.

| | |
|---|---|
| Avocado oil | 270 |
| Safflower oil | 265 |
| Mustard oil | 255 |
| Rice bran oil | 255 |
| Ghee, clarified butter | 250 |
| Sunflower oil | 245 |
| Olive oil | 240 |
| Canola oil | 240 |
| Soybean oil | 240 |
| Corn oil | 235 |
| Sesame oil | 230 |
| Peanut oil | 230 |
| Palm oil | 230 |
| Olive oil, refined | 225 |
| Almond oil | 220 |
| Cottonseed oil | 215 |
| Olive oil, virgin | 215 |
| Grapeseed oil | 205 |
| Walnut oil | 205 |
| Lard | 200 |
| Butter, salted | 200 |
| Butter, unsalted | 200 |
| Olive oil, extra virgin | 190 |
| Coconut oil | 175 |
| Sesame oil | 175 |
| Hemp oil | 165 |
| Margarine, soft | 160 |
| Butter oil, anhydrous | 150 |
| Margarine, hard | 150 |

Table 2 below shows the tempering temperature of a number of commonly tempered spices.

TABLE 2
Optimal Cooking/Flavor Temperatures

| | MAX FLAVOR | SMOKE |
|---|---|---|
| SPICES | TEMP, ° F. | POINT, ° F. |
| Carom seeds | 490-500 | 530 |
| Cloves | 470-480 | 500 |
| Cinnamon | 470-480 | 490 |
| Cumin | 450-460 | 480 |
| Bay leaf | 430-450 | 460 |
| Garlic | 400-420 | 400 |
| Ginger | 400-420 | 400 |
| Hingh | 450-480 | 460 |
| Red chile powder | 380-410 | 420-430 |
| Dry chile peppers, whole | 500 | 550 |
| Turmeric | 470-480 | 490 |
| Mustard seeds | 470-480 | 550 |
| Fenugreek | 450-460 | 450 |
| Star anise | 410-430 | 480 |

The spice tempering device 10 can include temperature indicators to assist the user in determining when to add each spice. The temperature indicators can be color coded to further assist the user. The design and placement of temperature probes and indicators are well known by those skilled in the art.

The spice tempering device 10 may further include one or more colors, designs, and/or patterns disposed on at least a portion thereof. The color(s), design(s), and/or pattern(s) may include, for example but not by way of limitation, packaging and/or labeling information, instructions for use, promotional material, company information, logos/trademarks, combinations thereof, and the like. The color(s), design(s) and/or pattern(s) may be disposed on the spice tempering device 10 by any method known in the art, including but not limited to, printing, etching, embossing, texturing, coating, lacquering, application during molding, and the like. The color(s), design(s) and/or pattern(s) may be applied separately or simultaneously and/or may be characterized totally or partially by pearlescent, translucent, transparent, iridescent, or other similar qualities. Each of the above-named characteristics may occur alone or in combination.

Another embodiment of the presently disclosed inventive concept(s) is directed to a kit containing at least the spice tempering device described above. The kits of the presently disclosed inventive concept(s) may further include a display unit on which at least a portion of the packaged product(s)/kit(s) may be disposed and thereby displayed. Display units are well known in the art, and therefore no further discussion thereof is deemed necessary.

The kits of the presently disclosed inventive concept(s) may further include one or more sets of instructions. The instructions may explain how to use the kit(s) for display of the packaged product(s) present therein and/or how to produce a display assembly that includes one or more packaged product(s) of the kit(s) disposed on a display unit. Any type of format capable of conveying the desired information (and/or directing a user's attention to a location where said information can be found) may be utilized as the instructions described or otherwise contemplated herein. Non-limiting examples of formats in which the instructions may be provided include written wording and/or pictorial drawings, hardware, software, a website address, a bar code (such as but not limited to, a QR code) that is readable by an imaging device/code reader, combinations thereof, and the like. The instructions may contain static information, or the instructions may be in an interactive form.

Although the presently disclosed inventive concept(s) has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the presently disclosed inventive concept(s).

Changes may be made in the construction and the operation of the various components, elements, and assemblies described herein, as well as in the steps or the sequence of steps of the methods described herein, without departing from the spirit and scope of the presently disclosed inventive concept(s).

What is claimed is:

1. A spice tempering device comprising:
a truncated conical container having a container sidewall, an open top, a closed base, and an inner cavity within, the closed base parallel to open top, the closed base having a diameter smaller than a diameter of the open top;
a truncated conical support member having an upper rim attached about an outer surface of the container sidewall;
a fitted strainer basket insertable through the open top and into the inner cavity of the truncated conical container, the strainer basket having a strainer sidewall, an open top, and a strainer handle extending outwardly from an upper portion of the strainer basket; and
a lid fitting over the open top of the truncated conical container and the strainer basket.

2. The spice tempering device of claim 1, wherein the at least one support member comprises three or more legs extending from the outer surface of the container sidewall downward to a position level with or lower than the closed base.

3. The spice tempering device of claim 1, wherein the at least one support member comprises a truncated conical support member having an upper rim attached about the outer surface of the container sidewall and extending downward to a position level with or lower than the closed base.

4. The spice tempering device of claim 3, further comprising a temperature indicator in communication with the temperature sensor.

5. The spice tempering device of claim 1, further comprising one or more handles on the container sidewall.

6. The spice tempering device of claim 1, further comprising a temperature sensor positioned on an inner surface of the container sidewall near, but not on, the closed base.

7. The spice tempering device of claim 1, wherein the lid comprises a knob attached to a spice divider atop a spice tray.

8. The spice tempering device of claim 7, wherein the spice divider comprises multiple slotted compartments, and wherein a slot in the spice tray can be positioned under a desired slotted compartment by twisting the knob.

9. The spice tempering device of claim 8, wherein twisting the knob allows spices in the desired slotted compartment to fall into the fitted strainer basket for tempering in hot oil.

10. A method for tempering spices, the method comprising the steps of:
partially filling an inner cavity of a spice tempering device with an oil having a smoke point higher than the tempering temperature of the spices to be tempered, the spice tempering device comprising a truncated conical container having a container sidewall, an open top, a closed base, and the inner cavity within, the closed base parallel to open top; a truncated conical support member having an upper rim attached about an outer surface of the container sidewall; and a fitted strainer basket insertable through the open top and into the inner cavity of the truncated conical container, the strainer basket having a strainer sidewall, an open top, and a strainer handle extending outwardly from an upper portion of the strainer basket;
placing a first spice in the strainer basket, the first spice having the highest tempering temperature;
inserting the strainer basket into the inner cavity of the spice tempering device and heating the oil and first spice therein to a temperature sufficient to temper the first spice;
causing the oil to cool to the tempering temperature of a second spice, and once cooled, adding the second spice to the strainer basket and tempering the second spice;
removing the strainer basket from the inner cavity and discarding any strained spice; and
pouring the oil from truncated conical container onto a food, the oil now containing flavors from the tempered spices.

11. The method of claim 7, further comprising the step of:
prior to the step of pouring the oil from the truncated conical container, allowing the oil to cool to the tempering temperature of a third spice, and once cooled, adding the third spice to the strainer basket and tempering the third spice.

12. The method of claim 7, wherein the oil is heated in the spice tempering device by placing the device in a skillet such that the closed base is in contact with a heated surface of the skillet.
